(19) United States
(12) Patent Application Publication
(10) Pub. No.: US 2012/0191329 A1
(43) Pub. Date: Jul. 26, 2012

(54) METHOD FOR OPERATING A CONTROLLER FOR A STARTER DEVICE, CONTROLLER, AND COMPUTER PROGRAM PRODUCT

(76) Inventors: Markus Roessle, Stuttgart (DE); Stefan Tumback, Stuttgart (DE); Falco Sengebusch, Stuttgart-Feuerbach (DE)

(21) Appl. No.: 13/388,256

(22) PCT Filed: Jul. 29, 2010
(86) PCT No.: PCT/EP2010/060997

§ 371 Date: Apr. 12, 2012

(30) Foreign Application Priority Data
Aug. 14, 2009 (DE) 10 2009 028 535.0

(51) Int. Cl. F02D 28/00

(52) U.S. Cl. 701/113

(57) ABSTRACT

A method is described for operating a controller for a starting apparatus for starting an internal combustion engine in a vehicle, the controller controlling an engagement apparatus, which encompasses the starting apparatus, so as to engage a starter pinion into the ring gear of an internal combustion engine, in particular using a start-stop operating strategy. In order to improve vehicle convenience by the fact that start-stop operation can be implemented with quick and reliable availability of the internal combustion engine, at least one operating parameter of the engagement apparatus is sensed and evaluated by the controller, and the controller adapts the control of the engagement apparatus to the at least one operating parameter.

### FIELD OF THE INVENTION

The present invention relates to a method for operating a controller for a starting apparatus for starting an internal combustion engine in a vehicle, the controller controlling an engagement apparatus, which encompasses the starting apparatus, so as to engage a starter pinion into the ring gear of an internal combustion engine, in particular using a start-stop operating strategy. The present invention further relates to a computer program product having a starter motor, a starter relay, and a starter pinion that can be extended and retracted by the starter relay, start-stop operation of an internal combustion engine being implementable using the controller, and the starter relay and starter motor being controllable separately and in defined fashion by the controller.

### BACKGROUND INFORMATION

Conventionally, in order to save fuel and reduce emissions, the internal combustion engine in a vehicle is forced to stop briefly, for example at traffic lights or because of traffic obstacles, by way of a motor controller, in accordance with specific shutoff conditions, in particular in accordance with a specific time sequence. It is further conventional to start an internal combustion engine by way of a starter motor that has a starter pinion which is engaged into a ring gear of an internal combustion engine. For this kind of design of an internal combustion that is started with the aid of a starter pinion, there exist minimum restart times that must elapse before the internal combustion engine can be restarted, since the stationary starter pinion must not be engaged into a rotating ring gear.

There are developments for already engaging the starter pinion into the ring gear while the internal combustion engine is coasting down.

German Patent Application No. DE 10 2006 011 644 A1 describes an apparatus and a method for operating an apparatus having a starter pinion and a ring gear of an internal combustion engine, the rotation speed of the ring gear and of the starter pinion being ascertained in order to engage the starter pinion, after shutoff of the internal combustion engine, at substantially the same rotation speed upon coast-down of the internal combustion engine. The starter pinion remains in an engaged state until the internal combustion engine is started up.

German Patent Application No. DE 10 2006 039 112 A1 describes a method for determining the rotation speed of the starter motor for a motor vehicle combustion engine. It further describes the fact that the starter motor encompasses a separate starter control unit in order to calculate the rotation speed of the starter motor and, in start-stop operation, to accelerate the pinion of the starter motor when a self-start of the combustion engine is no longer possible because the rotation speed has dropped. The pinion is extended into the ring gear of the coasting-down combustion engine at a substantially synchronous rotation speed. This existing art is regarded as being the closest.

German Patent Application No. DE 10 2005 004 326 A1 describes a starting apparatus for a combustion engine, with a separate engaging and starting procedure. For this, the starting apparatus has a control unit that separately controls a starter motor and an actuating member in order to extend a starter pinion. The starter pinion can be engaged into the ring gear by the control unit before a vehicle starting procedure, before the driver has issued a new start request. In this context, an extending relay embodied as an actuating member is already being controlled during a coast-down phase of the combustion engine. The rotation speed threshold here is well below the idle speed of the engine, in order to keep wear on the engagement apparatus as low as possible. In order to avoid voltage dips in the vehicle electrical system because of a very high starting current of the starter motor, a smooth startup is implemented by the control unit, for example by cycle-timing the starter current. The performance capability of the vehicle electrical system is monitored by analyzing the battery state, and the starter motor is correspondingly cycled or supplied with current.

German Patent Application No. DE 10 2005 021 227 A1 describes a starting apparatus for an internal combustion engine in motor vehicles having a control unit, a starter relay, a starter pinion, and a starter motor, for a start-stop operating strategy.

It is an object of the present invention to further develop a method, a computer program product, and a controller of the kind cited initially in such a way as to improve vehicle convenience, by the fact that start-stop operation can be implemented with quick and reliable availability of the internal combustion engine.

### SUMMARY

One aspect of an example embodiment of the present invention is to sense and evaluate at least one operating parameter that influences the engagement apparatus, and to control the engagement apparatus for start-stop operation, via the controller, in a manner adapted to the at least one operating parameter. In accordance with the present invention, operating parameters that have an influence on the engagement procedure of the starter pinion in order to engage the starter pinion are taken into account, in start-stop operation in the operating mode of a coasting-down internal combustion engine, with the smallest possible difference in speed between the ring gear and starter pinion. Because the engagement time span is dependent on specific operating parameters, the intention is to sense these operating parameters in order to arrive more accurately at a correct engagement instant, i.e. in order for the rotating tooth flanks of the ring gear and the starter pinion to exhibit a substantially synchronous rotation speed. The wear and noise generation of a starting apparatus are thus minimized even in start-stop operation.

According to a preferred embodiment, the temperature of the engagement apparatus is sensed as an operating parameter. The temperature is a variable magnitude that modifies the duration of the engagement process and may be important for an exact, synchronous engagement procedure.

According to an embodiment that refines the present invention, the controller (5) adapts the control of the engagement apparatus by way of at least one, preferably two settable control parameters. In the case of a single operating parameter, for example, one control parameter can thus be implemented for a simple controller. In order to achieve greater flexibility, preferably two control parameters such as, in particular, the control instant and the control power output, can be adapted in combined fashion. The correct instant at which the starter pinion engages into a ring gear of a coasting-down engine can thus be implemented even more accurately.

The at least one operating parameter can be sensed, for example, by way of at least one separate sensor that is in information contact with the controller.

According to an additionally preferred method that refines the present invention, the engagement apparatus is used by the controller as a sensor of at least one operating parameter, in particular to determine the temperature, a position of the starter pinion, and the speed of the starter pinion. The engagement apparatus is thus energized with a test current, and the test current is evaluated by the controller using an evaluation apparatus, and the temperature, the position of the starter pinion, or the speed of the starter pinion is ascertained therefrom. The engagement apparatus preferably has two separately energizable exciter windings for detection, and the controller encompasses a measurement and evaluation apparatus. Values of operating parameters are thus measured directly at the engagement apparatus, and previously without additional component outlay or additional sensors. The measurement and evaluation apparatus is preferably already built into the controller in order to perform further optimized and advantageous functions for a start-stop operating method.

According to a particularly simple example method configuration, at least one control parameter is ascertained by the controller from at least one dependent variable operating parameter via a stored characteristic curve. An interrelation between operating parameters and control parameters, for example via a temperature-dependent characteristic curve, is a particularly simple method. By preference, a characteristic curve for the elapsed time until the starter pinion encounters the ring gear, as a function of relay temperature, is stored in the controller. Alternatively, a characteristic curve for the relay temperature in terms of the change in engagement time span, with respect to a reference temperature, can also be stored. This alternative is useful if further temperature-independent influences on the engagement time span are taken into account. It is thus possible, in accordance with a first preferred method, to take into account the influence of temperature on the motion of the starter pinion when advanced by an engagement relay, and to set more accurately the instant at which the starter pinion encounters the ring gear in the context of the engagement procedure.

According to an alternative method, the at least one control parameter is ascertained by the controller from at least one dependent variable operating parameter, in particular an operating temperature, via a stored characteristic curve with respect to at least one operating parameter reference value, by shifting the characteristic curve with respect to the reference value. Shifting a characteristic curve with respect to reference variables allows an influence on of the control parameter to be introduced via a variety of operating parameters. For example, a characteristics diagram of the pinion position or pinion speed against temperature, and against the time during which the relay is acted upon by a specific energization, can be stored. For a known pinion travel, for example, the elapsed time until the pinion reaches the ring gear can be determined from this characteristic curve.

In an alternative, additionally preferred method, at least one control parameter is ascertained here from a multidimensional characteristics diagram. At least one further input variable, or a combination of subsequent input variables, constituting a value of various operating parameters, will therefore be incorporated in the context of the above-described method; possible values of operating parameters are the present pinion traveled by the relay armature before the starter pinion is set in motion.

According to an example embodiment that refines the present invention, the at least one control parameter is ascertained from a physical model, in particular a temperature model, operating parameters such as an armature position, an advance distance, and a speed being determined and calculated by integration.

According to an alternative embodiment, the control parameter is ascertained from a function of the temperature T, the pinion position p, and the pinion speed v. An estimate of the present state of the starter pinion can thus be made from these values, and can be used as a basis for control parameters for controlling the motion of the starter pinion.

In an advantageous method, control parameters are learned in relation to operating parameter values. For example, the temperature influence can be implemented as a learning function of the controller, so that the parameter values are checked and optionally adapted by a control function by, for example, recording the actual elapsed time prior to engagement of the starter pinion into the ring gear.

In accordance with a rule, for example a time span ascertained from average values, this new time span is adapted either continuously or at intervals. The engagement apparatus is preferably embodied as a measurement sensor, with a dual-function switching winding, by the fact that the induced voltage in the switching winding is determined. Or other current values and/or voltage values in the engagement apparatus are evaluated as sensor values.

In order to minimize the temperature dependence of the engagement apparatus, in particular, a temperature-dependent extension time span of the starter pinion is compensated for by a variable control or, in particular, by regulation of the control power level and/or the control instants. A starter pinion can thus be engaged into a coasting-down internal combustion engine over a wide operating range with highly accurate synchronization, more exactly, and with minimized noise.

The operating range of the engagement apparatus extends over a wide temperature range that occurs in the context of start-stop operation.

A computer program product is also described, which is loadable into a program memory having program instructions in order to carry out all steps of the above-described method when the program is executed in a controller.

The computer program product has the advantage that it requires no additional components in the vehicle, but instead can be implemented, as a module, as a method in controllers in the vehicle. The computer program product can easily be adapted to individual, empirical, and improved values. A self-teaching function can easily be implemented.

A controller is also described which encompasses a sensing device for operating parameters and an evaluation apparatus with variable power level control of the starter relay in order to compensate for an, in particular, temperature-dependent extension time span of the starter pinion. Precisely functioning start-stop operation with an elevated performance capability can thus be realized.

It is understood that the features described above and those explained below are usable not only in the respective combination indicated, but also in other combinations.

### BRIEF DESCRIPTION OF THE DRAWINGS

The present invention is further explained below with reference to figures.

FIG. 1 shows a diagram of a starting apparatus having an example controller according to the present invention.

FIG. 2 shows a flow chart of an example method according to the present invention.

FIG. 3 shows a time/distance/temperature diagram.

FIG. 4 shows a time/distance/temperature diagram.

FIG. 5 shows a current/voltage/distance/time diagram of signal curves in the context of the engagement procedure.

FIG. 6 shows an equivalent circuit diagram of the engagement winding.

### DETAILED DESCRIPTION OF EXAMPLE EMBODIMENTS

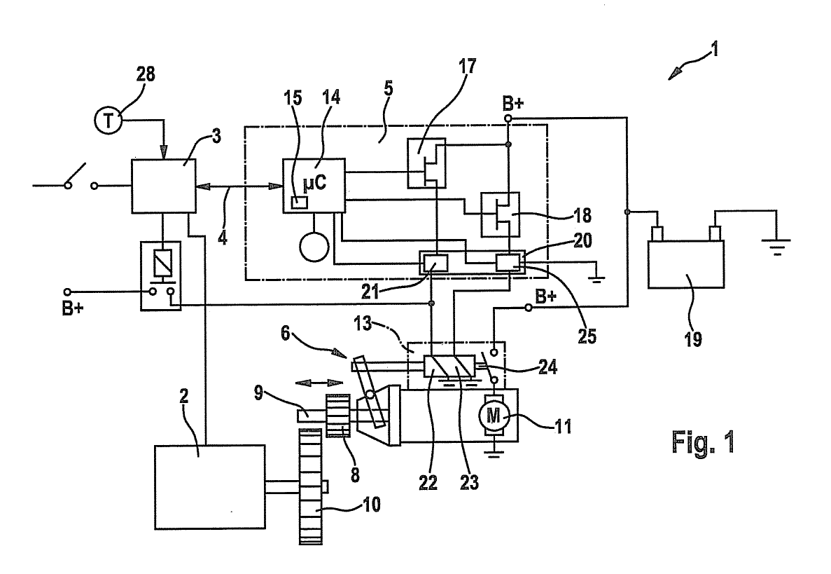

FIG. 1 shows a diagram of a starting apparatus 1, having a starter motor 11 and a starter relay 13, for starting an internal combustion engine 2. Internal combustion engine 2 is connected to an engine controller 3 that communicates via a communication line 4, for example a CAN bus, with a controller 5 of starting apparatus 1.

Engine controller 3 encompasses a start-stop operating mode according to which the internal combustion engine is stopped on the basis of shutoff conditions or started on the basis of switch-on conditions. Engine controller 3 determines whether internal combustion engine 2 is shut off on the basis of a start-stop operating mode, and conveys corresponding information to controller 5. In order to increase the availability of internal combustion engine 2 in start-stop operation, an effort is made, in a special start-stop operating mode, to engage a starting pinion 8 of an engagement apparatus 6 into a ring gear 10 of a coasting-down internal combustion engine 2. Starter pinion 8 is disengaged again after the internal combustion engine 2 starts. In order to lengthen the service life of starter pinion 8, engagement apparatus 13, and ring gear 10, and to avoid a high degree of wear, it is a goal to engage starter pinion 8 at a maximally synchronous peripheral speed with respect to ring gear 10 of internal combustion engine 2. The time span that engagement apparatus 6 requires, by way of starter relay 13, for engagement, depends on a variety of operating parameters, in particular on the temperature of starter relay 13. According to the present invention, at least the temperature of starter relay 13 is taken into account.

The temperature can be sensed with an external temperature sensor 28. Temperature sensor 28 furnishes to engine controller 3 measured values that are conveyed to controller 5 for further processing. The temperature of engagement apparatus 6 can correspond substantially to the temperature range of the external temperature sensor. In order to obtain the temperature of the engagement apparatus without additional component outlay in terms of an external temperature sensor, and in order to recover highly accurate measured temperature values from starter relay 13, starter relay 13 itself is used by the modified controller 5 as a temperature sensor.

FIG. 1 shows a particularly preferred embodiment of starter relay 13. In accordance with this embodiment, starter relay 13 has an engagement winding 22 and a switching winding 23. Energization of switching winding 23 causes a relay contact to close, so that starter motor 11 is acted upon directly by a current of battery 19. Both relay windings can be separately energized by a battery 19 through power switches 17 and 18. The currents and voltages can each be individually sensed by a sensing device 20 so that with the aid of controller 5, the currents sensed by sensing device 20 are evaluated and operating parameters, preferably the temperature, are derived therefrom, so that starter relay 13 is adapted to the operating parameters and is controlled. Starter relay 13 is energized with a small current in order to measure the temperature. The current is so small that starter pinion 8 does not become engaged. As a result of an inductive behavior of the relay coil, the current can be measured by way of sensing device 20, using a measurement device 21 or 25. The temperature influence can be taken into account in the operating behavior of starter relay 13. A synchronous engagement procedure, in which the temperature influence is compensated for, can thus be carried out even more exactly. The control of engagement winding 22 is settable by way of two control parameters. A first control parameter is the engagement instant, which can be set forward or backward from a reference value depending on the temperature; and a further, second control parameter is the control power level, which can be either raised or lowered.

Further operating parameters are determination of the position of the armature in starter relay 13, and the speed of the armature and thus the speed of starter pinion 8.

Sensing device 20 is connected to a microcomputer 14 having a program memory 15, and evaluates the measured results in order to ascertain the control parameters in order to energize power switches 17, 18 at the correct and desired instant. All the Figures show only schematic depictions that are not to scale. Reference is otherwise made in particular to the graphic depictions may be used in connection with the present invention.

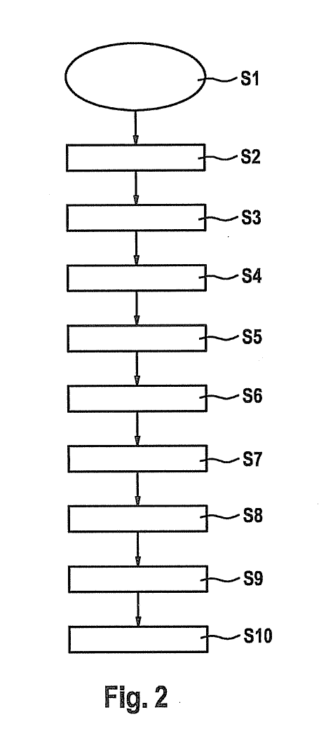

FIG. 2 is a flow chart of a particular start-stop operating strategy in which the example method according to the present invention is utilized with controller 5 according to the present invention.

In a first step S1, the internal combustion engine is shut off on the basis of specific, defined start-stop conditions, for example because torque has not been requested by the driver for a specific time, e.g., more than four seconds, and the speed of the vehicle is zero or is trending strongly toward zero.

In a subsequent second step S2, which preferably nevertheless need not obligatorily be the next one but instead can also occur somewhat later in the sequence, at least one operating parameter of the engagement apparatus, preferably the temperature of the engagement apparatus, is sensed in accordance with a method yet to be described. Sensing of the temperature is accomplished by the use of starter relay 13 as a sensor. The temperature is derived from measured values of the sensor.

In a third step S3, for example, the pinion position is sensed as a further operating parameter, by evaluating the briefly energized engagement apparatus 6. The pinion position is defined by the position of the armature.

In a fourth step S4, an instant at which the peripheral speed of ring gear 10 of the coasting-down internal combustion engine 2 will be substantially synchronous with the peripheral speed of starter pinion 8 is determined, so that starter pinion 8 is engaged at the previously characterized instant with as little noise and wear as possible.

In a fifth step S5, starter motor 11 is accelerated.

In a sixth step S6, the rotation speed of internal combustion engine 2 and of starter motor 11 is continuously measured. A check is made here as to whether the engagement instant is being adhered to, or whether control parameters or the engagement instant need to be corrected.

In a seventh step S7, engagement apparatus 13 is controlled using at least one control parameter, preferably two control parameters, corresponding to the evaluated values of at least one operating parameter, so that tooth flanks of starter pinion 8 encounter tooth flanks of ring gear 10 at the desired and exact instant at which the peripheral speeds are substantially synchronous. Monitoring is accomplished by measuring the currents or voltage of starter relay 13.

If the actual values deviate from predefined target values, the measured values are then evaluated and, in a step S9, as a self-teaching function, values of at least one control parameter are correspondingly corrected in relation to values of at least one operating parameter. The continuous self-teaching function, as well as an initial registration function, are thus implemented.

In a step S10, engine 2 is started by energizing starter motor 11 while a starter pinion 8 is engaged into ring gear 10. Step S10 is not carried out until a torque request is issued by the driver to engine controller 3, for example because he or she wishes to begin moving. Because starter pinion 8 is already engaged into ring gear 10, the availability of the internal combustion engine in terms of time is enhanced, and the request to begin moving can be implemented more quickly.

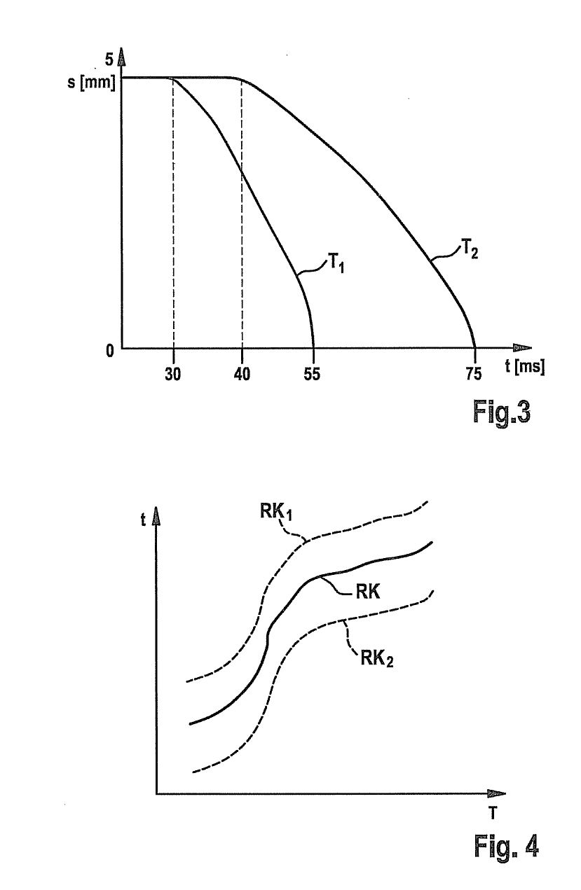

FIG. 3 is a time/distance diagram having two characteristic curves. A first characteristic curve T1 shows, upon energization of engagement winding 22, how fast starter pinion 8 moves during the engagement procedure. Characteristic curve T1 is recorded, for example, at a temperature of 25° C. After approximately 30 ms, a first response behavior occurs, so that after approx. 25 ms an engagement distance of 5 mm has been traveled by starter pinion 8. A characteristic curve T2 is recorded at a temperature of starter relay 13 of approximately 115° C. As is evident from FIG. 3, the response behavior is distinctly delayed. In addition, the engagement speed is slower as compared with characteristic curve T1. Starter relay 13 does not respond until approx. 43 ms, and requires approx. 35 ms for the advance distance of approx. 5 mm. Depending on the temperature, engagement winding 22 must therefore be energized correspondingly earlier, i.e., approx. 25 ms earlier at, for example, a temperature of 115° C. as compared with a temperature of 25° C., or must be acted upon by a higher control power level, so that starter pinion 8 encounters the tooth flanks of the coasting-down ring gear 10 at the desired time.

According to a first preferred simple method, the time span t for engagement of starter pinion 8 is determined by a function f depending on the temperature T of starter relay 13. Time span t is the time span required for starter pinion 8 to reach ring gear 10. FIG. 3 thus shows t=f(T) as characteristic curves.

Alternatively, time span t can be corrected, by addition, multiplication, or use of an exponent, using a value dependent on temperature T of starter relay 13. The function is then t=t₀+f(T) or t=t₀*f(T) or t=t₀^{f(T)}. In this example method it is assumed that the further influencing variables of various operating parameters are ignored in favor of the temperature of starter relay 8, or are overlaid by the example method described here. It is therefore assumed in the context of the example method according to FIG. 3 that the spacing from the starter pinion to ring gear 10, i.e., the advance distance, remains the same. The advance distance or the pinion-ring gear spacing can change minimally as a result of wear and aging phenomena, which may be important globally in terms of control application but is ignored in accordance with the simple method. By way of a learning function, the characteristic curves can in this case be correspondingly shifted and re-saved.

FIG. 4 shows a characteristics diagram for the time span t, i.e., the time required for starter pinion 8 to reach ring gear 10, as a function of the temperature T of starter relay 13. FIG. 4 proceeds from a reference characteristic curve RK. This characteristic curve RK is shifted in parallel fashion as a function of a further operating parameter, either upward to the dashed characteristic curve RK₁ or downward to the dashed characteristic curve RK₂. The further operating parameter value is, for example, the present ring gear-pinion spacing I or the advance distance S of the armature. The advance distance S of the armature differs from the ring gear-pinion spacing by an amount equal to a defined clearance in starter relay 13. The ring gear-pinion spacing I is, for example, increased in the context of characteristic curve RK₁, and decreased for characteristic curve RK₂.

In a second example method according to the present invention the position p of the starter pinion or the speed v of starter pinion 8 is therefore described, after a specific time and at a specific temperature, by a reference characteristic curve RK: p=f(t, T) or v=f(t, T). A superposition with further effects is, however, also possible. In accordance with this method, the present state of starter pinion 8, i.e., the position and speed, are determined, and this serves as a basis for controlling starter relay 13 for pinion motion.

An improvement of the above-described method according to the present invention is possible if further measured variables and operating parameters are introduced into the characteristics diagram. The present position of starter pinion 8 is preferably sensed from a measurement using sensing device 20, and an evaluation in controller 5, of the induced voltage in switching winding 23. The pinion speed can be derived therefrom. In addition, the present current in engagement winding 22 can be adapted by starter relay 13. Furthermore, the actual advance distance that must be traveled by the armature of starter relay 13 before the pinion begins to move can also additionally be introduced. In order to take into account these further measured variables and operating parameters, the characteristics diagrams are expanded to include more dimensions than those in FIGS. 3 and 4. Preferably, in order to avoid an increased need for memory space, in some cases only two interpolation points for one dimension are sufficient in order to span a characteristics diagram according to the present invention.

In order to execute the example method described with reference to FIGS. 2, 3, and 4, the characteristic curves and characteristics diagrams are ascertained and stored in a manner specific to the vehicle model.

For initial registration of the data for the characteristic curves and characteristics diagrams, the induced voltage in the switching winding upon a motion of the starter pinion is evaluated in terms of the position of the starter pinion, the speed, and (when a tooth is reached) the tooth position with regard to the deceleration of the starter pinion. It is, thus, possible to correct the characteristic curves and characteristics diagrams at each working point that has been established, and save them with new data. In order to verify and save the individual data, provision is preferably made to execute the engagement procedure several times at least for initial registration, so that the corresponding measurement errors are avoided, and relevant data of the characteristic curves and characteristics diagrams are corrected as a function of the probability of occurrence. The example method can be applied at the factory prior to delivery, or in the context of maintenance, or also as a continuing process over the service life of the vehicle for example.

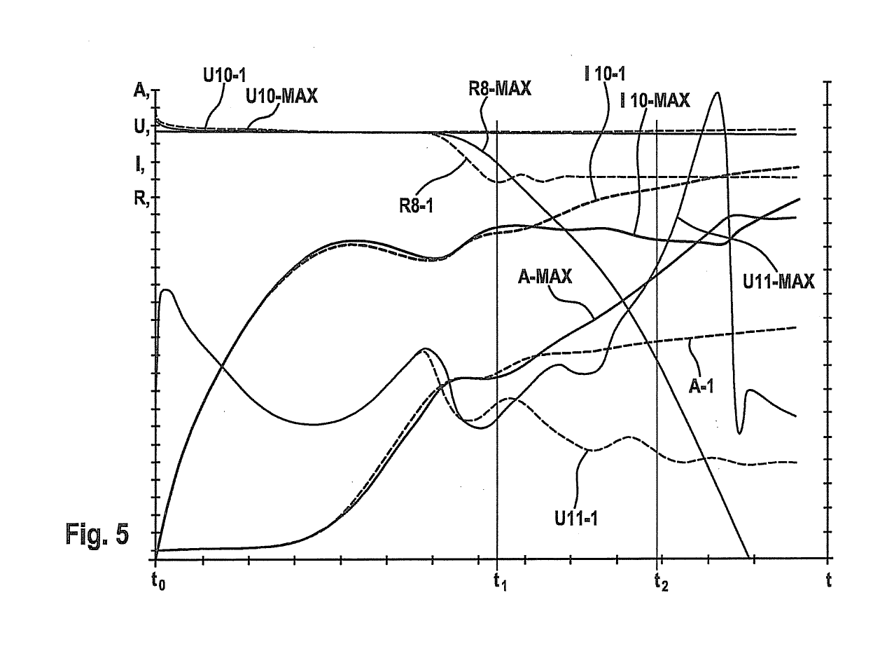

FIG. 5 shows the signal curves for the applied voltage U10, current I10, travel R8 of starter pinion 8, induced voltage U11, and a motion distance A of the armature in starter relay 13, in each case with an index “−1” for a short engagement motion and “−MAX” for an engagement procedure. These signal curves are depicted merely by way of example, in order to show that the armature position or pinion position and speed can be detected and evaluated by measuring induction in the starting apparatus. From these signal curves, a self-teaching function can be created by way of a specific evaluation of the signal curves.

According to a further preferred fifth method, in order to avoid the complexity of characteristics diagrams as described in methods 1 to 4 and in order to eliminate high costs for the acquisition of reliable measured variables and also an automatic application of characteristic curves and characteristics diagrams in accordance with the above-described fourth method, according to a preferred fifth method a physical model with reference to temperature is stored in the controller. Relevant effects, such as the dynamics of the advance process, temperature dependence, and optionally aging, are described by the physical model. With the aid of this model it is possible to determine the forces acting at the present instant on the armature of starter relay 13, and to calculate its position and speed by integration. Adjusting the model to actual behavior requires far fewer measurement points, with lower accuracy, than is the case, for example, with a method having a learning function. Adjustment can be carried out, for example, with the aid of a Kalmann filter.

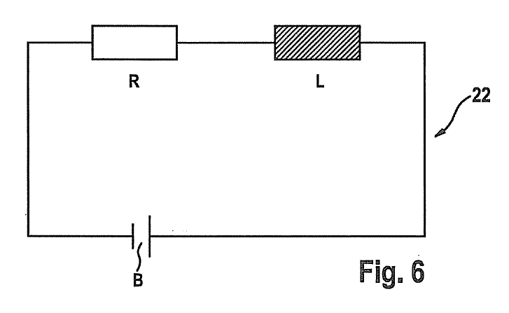

A model of this kind is preferably constructed as follows: The electrical operations are described, considering the coil of the starter relay as a series circuit having an inductance L and an ohmic resistance R. FIG. 6 shows, for this purpose, an equivalent circuit diagram of an engagement winding 22 of starter relay 13.

The applicable formula is thus I=(U/R)(1−e^{Rt/L}) where I [A] is the current flowing through engagement winding 22, U [V] is the voltage drop across the relay coil, R [ohms] is the ohmic resistance of the coil, t [s] is time, and L [H] is the inductance of the coil.

From the calculated current, together with the position of the armature, it is then possible to ascertain the force acting on the relay armature. The individual position of the starter pinion can be calculated if the advance distance is also included.

In this model, only the resistance R is dependent on temperature. The change in temperature can be described by:

R_{engagement winding 22}(T)=R_{engagement winding 22}(T₀)*(1+αT_{Cu}(T−T₀)).

R_{engagement winding 22} is the ohmic resistance of the engagement winding, T is the temperature [K] at which the ohmic resistance is to be determined, and T₀ is the temperature [K] at which the ohmic resistance is known, αT_{Cu} is the coefficient [K⁻¹] of copper. Mechanical processes are also described. The main mechanical changes in engagement apparatus 6 are the change in friction, the longitudinal expansion, and the change in the behavior of the springs.

The longitudinal expansion can be described relatively easily as l(T)=l(T)*(1+αl(T−T₀)). l is the expansion [m] of the material in question in one dimension, T is the temperature [K] at which the expansion is determined, Tₒ is the temperature [K] at which the expansion is known, and αl is the expansion coefficient [m/K].

According to a further preferred sixth method, the current of engagement winding 22 is regulated. The influence of temperature on the dynamics of the starter relay is therefore completely eliminated by modifying the electrical resistance in the engagement winding. The force of the relay coil depends substantially on the position of the armature and on the current through the engagement winding. The dynamics of the starter relay are thus dependent on temperature.

It is thus possible, by targeted regulation of the current of the engagement winding, which as a rule is predefined by the supply battery, to eliminate the temperature influence so that the starter pinion always experiences substantially the same engagement time span. Instead of controlling the position of the starter pinion, therefore, the pinion-ring gear spacing is regulated. The regulation system ensures that the starter pinion position not only is reached exactly, but is also traveled to, and engaged, at the correct speed.

1-12. (canceled)

13. A method for operating a controller for a starting apparatus for starting an internal combustion engine in a vehicle, the controller controlling an engagement apparatus, which encompasses the starting apparatus, so as to engage a starter pinion into a ring gear of the internal combustion engine using a start-stop operating strategy, the method comprising:
sensing at least one operating parameter of the engagement apparatus, wherein the engagement apparatus is used by the controller as a sensor of the at least one operating parameter to determine at least one of a temperature of the engagement apparatus, a position of the engagement apparatus, and a speed of the engagement apparatus;
evaluating, by the controller, the at least one operating parameter; and
adapting, by the controller, the control of the engagement apparatus to the at least one operating parameter;
wherein the engagement apparatus has two separately energizable and detectable windings, and the controller encompasses a measurement and evaluation apparatus.

14. The method as recited in claim 13, wherein the temperature of the engagement apparatus is sensed as an operating parameter.

15. The method as recited in claim 13, wherein the controller adapts the control by way of at least one settable control parameters, at least one of the control parameters including at least one of a control instant and a control power output.

16. The method as recited in claim 13, wherein at least one control parameter used by the controller to control the engagement apparatus is ascertained by the controller from at least one dependent variable operating parameter via a stored characteristic curve.

17. The method as recited in claim 16, wherein the at least one control parameter is ascertained by the controller from at least one dependent variable operating parameter via a stored characteristic curve with respect to at least one operating parameter reference value, by shifting the characteristic curve with respect to the reference value.

18. The method as recited in claim 16, wherein the at least one control parameter is ascertained from a multidimensional characteristics diagram.

19. The method as recited in claim 16, wherein the at least one control parameter is ascertained from a temperature model, and the at least one operating parameters includes at least one of a position of the starter pinion and speed of the starter pinion, calculated by integration, and the sensing includes sensing armature position and advance distance.

20. The method as recited in claim 19, wherein parameters are learned in relation to operating parameter values.

21. The method as recited in claim 20, wherein the at least one of control parameter is ascertained as a function of the temperature, the pinion position, and the pinion speed.

22. The method as recited in claim 21, wherein a temperature-dependent extension time span of the starter pinion is compensated for one of by a variable control, or by regulation of the control power level.

23. A storage medium storing a computer program having program instructions that is loadable into a program memory, the computer program for operating a controller for a starting apparatus for starting an internal combustion engine in a vehicle, the controller controlling an engagement apparatus, which encompasses the starting apparatus, so as to engage a starter pinion into a ring gear of the internal combustion engine using a start-stop operating strategy, the computer program, when executed by a controller, causing the controller to perform the steps of:
sensing at least one operating parameter of the engagement apparatus wherein the engagement apparatus is used by the controller as a sensor of the at least one operating parameter to determine at least one of a temperature of the engagement apparatus, a position of the engagement apparatus, and a speed of the engagement apparatus;
evaluating, by the controller, the at least one operating parameter; and
adapting, by the controller, the control of the engagement apparatus to the at least one operating parameter;
wherein the engagement apparatus has two separately energizable and detectable windings, and the controller encompasses a measurement and evaluation apparatus.

24. A controller for a starting apparatus having a starter motor, a starter relay, and a starter pinion that can be extended and retracted by the starter relay, start-stop operation of an internal combustion engine being implemented with the controller, and the starter relay and the starter motor being controllable separately and in defined fashion by the controller, the controller including a sensing device for operating parameters and an evaluation apparatus with variable power level control of the starter relay in order to regulate in compensated fashion a temperature-dependent extension time span of the starter pinion, the controller configured to control an engagement apparatus, which encompasses the starting apparatus, so as to engage the starter pinion into a ring gear of the internal combustion engine, the engagement apparatus being used by the controller as a sensor of the at least one operating parameter, the at least one operating parameter being at least one of a temperature of the engagement apparatus, a position of the engagement apparatus, and a speed of the engagement apparatus, the engagement apparatus having two separately energizable and detectable windings, and the controller encompassing a measurement and evaluation apparatus.
